(19) United States
(12) Patent Application Publication
(10) Pub. No.: US 2007/0297733 A1
(43) Pub. Date: Dec. 27, 2007

(54) Mechanism to increase an optical link distance

(76) Inventors: Thomas Mader, Los Gatos, CA (US); Peter Kirkpatrick, San Francisco, CA (US); Jan Peeters Weem, Union City, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/475,580

(22) Filed: Jun. 26, 2006

(51) Int. Cl. G02B 6/02

(52) U.S. Cl. 385/123

(57) ABSTRACT

A system is disclosed. The system includes an optical fiber and a transceiver coupled to the optical fiber. The transceiver may operate according to both a single mode operation and a multi-mode operation.

### FIELD OF THE INVENTION

The present invention relates to fiber optic communications; more particularly, the present invention relates to increasing the distance of an optical link.

### BACKGROUND

Currently, optical input/output (I/O) is used in network systems to transmit data between computer system components. Optical I/O is able to attain higher system bandwidth with lower electromagnetic interference than conventional I/O methods. In order to implement optical I/O, radiant energy is coupled to a fiber optic waveguide from an optoelectronic integrated circuit (IC).

Typically, a fiber optic communication link includes a fiber optic transmitting device such as a laser, an optical interconnect link, and a light receiving element such as a photo detector. Currently, 10 Gbits/s optical links using a 850 nm transmitter over multi-mode fiber are implemented in network systems. However, at 10 Gbits/s modal dispersion causes optical signals to be degraded. As a result, the links over older multi-mode fiber are limited to approximately 30 meters, providing reach limitations in such fiber.

### DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 illustrates one embodiment of a network;

FIG. 2 illustrates one embodiment of a computer system; and

FIG. 3 illustrates one embodiment of a network controller.

### DETAILED DESCRIPTION

According to one embodiment, a mechanism to extend the distance of an optical link is disclosed. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

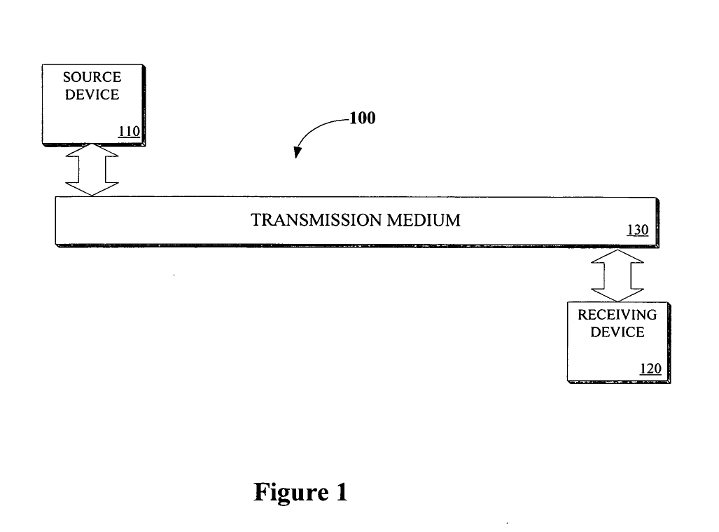

FIG. 1 illustrates one embodiment of a network 100. Network 100 includes a computer system 110 and a computer system 120 coupled via a transmission medium 130. In one embodiment, computer system 110 operates as a source device that transmits data to computer system 120, operating as a receiving device. The data may be, for example, a file, programming data, an executable, voice data, or other digital objects. The data is sent via data transmission medium 130.

According to one embodiment, network 100 is a wide area network, and data transmission medium 130 is implemented via an optical link. In a further embodiment, computer system 110 may be a data server, while computer system 120 is a personal computer system.

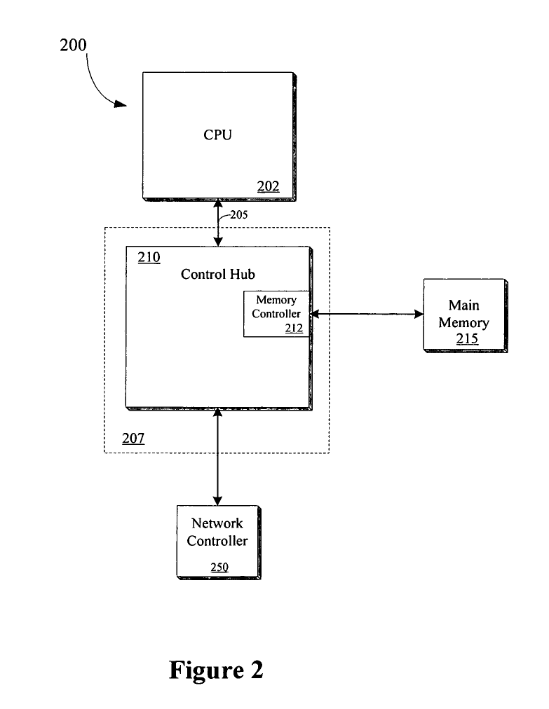

FIG. 2 is a block diagram of one embodiment of a computer system 200. Computer system 200 may be implemented as computer system 110 or computer system 120 (both shown in FIG. 1). Computer system 200 includes a central processing unit (CPU) 202 coupled to an interface 205. In one embodiment, CPU 202 is a processor in the Pentium® family of processors including the Pentium® IV processors available from Intel Corporation of Santa Clara, Calif. Alternatively, other CPUs may be used. In a further embodiment, CPU 202 may include multiple processor cores.

According to one embodiment, interface 205 is a front side bus (FSB) that communicates with a control hub 210 component of a chipset 207. Control hub 210 includes a memory controller 212 that is coupled to a main system memory 215. Main system memory 215 stores data and sequences of instructions and code represented by data signals that may be executed by CPU 102 or any other device included in system 200.

In one embodiment, main system memory 215 includes dynamic random access memory (DRAM); however, main system memory 215 may be implemented using other memory types. According to one embodiment, control hub 210 also provides an interface to input/output (I/O) devices within computer system 200.

For example control hub 210 may be coupled to a network controller 250. Network controller 250 that facilitates a wide area network between computer system 200 and a remote device. Note that in other embodiments, network controller 250 may be included within control hub 210. According to one embodiment, network controller 250 communicates data between computer system 110 and computer system 120 via a Bluetooth interface.

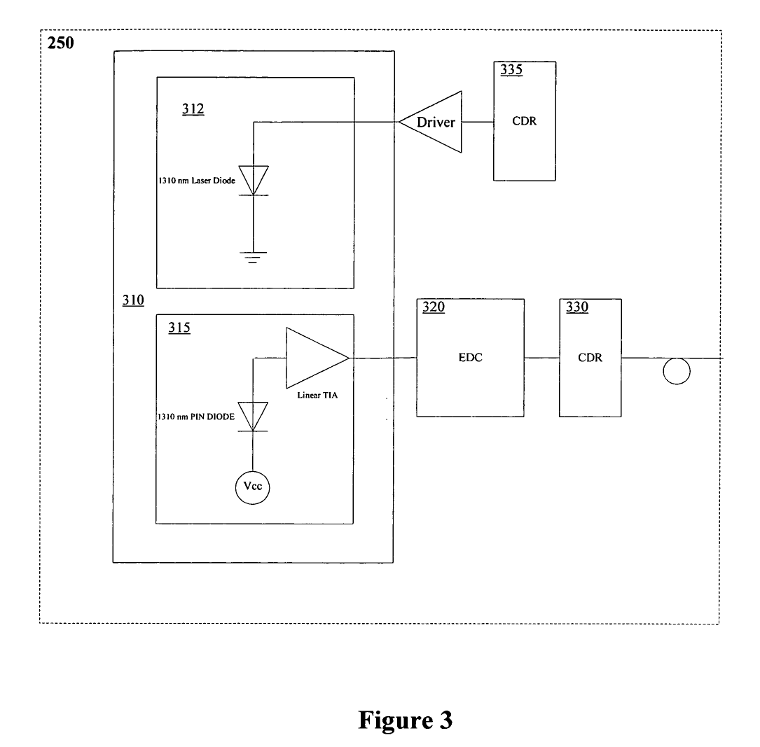

In one embodiment, the wide area network is implemented via a 10 Gbits/s optical link using multi-mode fiber coupled between computer system 110 and 120. According to one embodiment, network controller 250 includes a 10-gigabit transceiver that supports single mode as well as multi-mode operation. FIG. 3 illustrates one embodiment of network controller 250. Network controller 250 includes an optical transceiver 310, electrical dispersion compensation (EDC) unit 320 and clock and data recovery (CDR) modules 330 and 335.

Transceiver 310 transmits and receives optical signals over the network. Transceiver 310 includes a Transmitter Optical Sub Assembly (TOSA) 312 having a laser diode to perform electrical to optical power conversions. In one embodiment, the laser diode is a 1310 nm laser diode. In a further embodiment, transmitter 310 is capable of launching into both single mode and multi-mode fibers.

In addition, transceiver 310 includes a receiver 314. According to one embodiment, receiver 314 includes a Receiver Optical Sub Assembly (ROSA). According to one embodiment, receiver 315 performs single mode operation, in addition to LRM multi-mode operation, utilizing the multi-mode optics. Thus, receiver 315 automatically operates in either a single mode or multi-mode application. The dual operation is possible since a single mode beam is a subset of a multi-mode beam.

In one embodiment, receiver 314 includes a PIN photodiode and a transimpedance amplifier (TIA). The PIN photodiode transforms optical signals into an electrical current. In a further embodiment, the PIN photodiode is able to convert light to energy at a wavelength of 1310 nm.

The TIA boosts the strength of optical signals received at transceiver 310. According to one embodiment, the TIA is a linear TIA. A linear TIA enables a received signal to retain more information than a non-linear or limiting TIA. The TIA is capable of operating with a wide dynamic range. The TIA is coupled to EDC 320.

EDC 320 compensates for various types of fiber dispersion. For example, EDC 320 may compensate for modal dispersion in signals received at receiver 310 caused by a multimode fiber. In one embodiment, EDC 320 performs adaptive filter techniques on the received signals.

CDR 330 and 335 recover clock and data information received from an optical fiber by sampling the received signal to determine an optimum bit period and coping with dispersions. In addition, CDR 330 and 335 may automatically detect an optimum sampling point. In a further embodiment, EDC 320 and CDR 330 may be integrated to reduce space on a printed circuit board (PCB) on which network controller 250 is mounted.

The dual mode transceiver enables single mode Ethernet and Fiber channel protocols (e.g., 2-10 km), as well as SONET (e.g., 600 m) operation. Although described with reference to a network controller, embodiments of the above-described invention may be incorporated within the transceiver, which may be mounted on chipset 207.

Embodiments of the invention described above achieves a single mode transceiver for the price of a low cost multi-mode fiber transceiver by leveraging volume and lower cost lasers. In addition, a low cost benefit of EDC for short reach single mode applications is utilized.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

1. A system comprising:
an optical fiber; and
a 10GBASE-LRM transceiver coupled to the optical fiber, including:
a receiver to automatically receive signals in a single mode operation and a multi-mode operation; and
a transmitter capable of launching signals into the optical fiber if the optical fiber is a multimode optical fiber or a single mode optical fiber

2-4. (canceled)

5. The system of claim 1 further comprising an electrical dispersion compensation (EDC) unit to compensate for dispersion in optical signals received from the optical fiber.

6. The system of claim 5 wherein further comprising a clock and data recovery (CDR) module coupled to the EDC.

7. The system of claim 1 wherein the receiver comprises:
a transimpedance amplifier (TIA) coupled to the EDC; and
a PIN photodiode coupled to the TIA.

8. The system of claim 7 wherein the PIN photodiode operates at 1130 nm.

9. The system of claim 5 wherein the EDC performs adaptive filter techniques to compensate for modal dispersion.

10. A method comprising:
receiving a single mode or a multimode signal at a 10GBASE-LRM transceiver from an optical fiber;
the receiver operating according to single mode operation if the received signal is a single mode signal; and
the receiver operating according to multimode operation if the received signal is a multimode signal.

11. The method of claim 10 further comprising transmitting in single mode or multimode.

12. The method of claim 11 further comprising performing electrical dispersion compensation (EDC) on the signal to compensate for dispersion.

13. The method of claim 12 further comprising amplifying the signal at a transimpedance amplifier (TIA) after performing the EDC.

14. The method of claim 13 further comprising filtering the signal by performing clock and data recovery (CDR).

15. An optical transceiver comprising:
a 10GBASE-LRM transmitter; and
a 10GBASE-LRM receiver to automatically receive signals in a single mode operation and a multi-mode operation.

16. The transceiver of claim 15 wherein the transmitter is capable of launching signals into the optical fiber if the optical fiber is a multimode optical fiber or a single mode optical fiber.

17. The transceiver of claim 15 further comprising an electrical dispersion compensation (EDC) unit, coupled to the receiver, to compensate for dispersion in signals received from an optical fiber coupled to the transceiver.

18. The transceiver of claim 17 further comprising a clock and data recovery (CDR) module coupled to the EDC.

19. The transceiver of claim 17 wherein the receiver comprises:
a transimpedance amplifier (TIA) coupled to the EDC; and
a PIN photodiode coupled to the TIA.

20. The transceiver of claim 19 wherein the PIN photodiode operates at 1310 nm.
